(19) United States
(12) Patent Application Publication
(10) Pub. No.: US 2013/0298845 A1
(43) Pub. Date: Nov. 14, 2013

(54) APPARATUSES, SYSTEMS AND METHODS FOR WARNING FLYING BIRDS OF HAZARDS

(71) Applicant: Randall Blanchard, San DIego, CA (US)

(72) Inventor: Randall Blanchard, San DIego, CA (US)

(21) Appl. No.: 13/470,310

(22) Filed: May 12, 2012

(51) Int. Cl. A01M 29/10

(52) U.S. Cl. 119/713

(57) ABSTRACT

An apparatus is provided for warning bird of hazards, the apparatus comprising an enclosure, at least one light emitter for directing light within a predetermined beam width between ten and forty eight degrees full width half magnitude, a light emitter controller for controlling the at least one light emitter, and a power source. The light emitter controller provides power to and controls the one or more light emitters so that the light is emitted with a predetermined repetition rate so that light is emitted to provide a visual deterrent to birds on a flight path toward the hazard. Systems and methods of using the apparatus are also disclosed.

### BACKGROUND

The inventive subject matter relates generally to the field of bird warning devices. More specifically, the claimed subject matter relates to providing warnings to flying birds so that they divert their flight paths away from electrical power transmission lines and related structures.

Every year, more than 100 million birds are killed from flying into electrical power transmission lines. The danger to birds of these power lines has been studied and reported on for decades. The primary method to mitigate this problem has been to increase the visibility of the wires, especially the smaller ground wire, to the birds. At the present time, the prevailing approach to reducing bird collisions has been to add passive reflectors onto the wires. There are several sources for these bird flight diverters and they have been shown to provide some improvement in daylight conditions. However, they tend to be small in size and present a “point” source of visual awareness and, typically, the materials used have limited performance lifetime relative to a long term power line application. As such, there is room for significant improvements in providing a timely warning to birds.

In addition to power lines, avian protection can be extended to collisions with a variety of objects, as recognized by the FAA. Examples of other objects include communication tower structures and their guy wires and wind turbine generators. Known devices for bird protection against flying into hazards at nighttime include some passive reflective products with residual fluorescence.

As the large number of bird collisions show, a more aggressive response is needed to protect birds in all weather conditions. For example, night-migrating songbirds are at high risk at the present time. The FAA has mandated the protection of aircraft from power lines around airports for decades and these mandates have been followed by attaching line-powered warning lights to the wires near the airport. Unfortunately, the performance of these prior art illumination devices has not been an ideal match for the protection of birds and these warning lights can even be detrimental to the birds.

Further, in analyzing power line collisions, daytime bird field studies have shown that the top ground wires (also know as the shield wires) of the transmission lines cause the most collisions. This is because these wires are much smaller than the other power carrying wires and are not detected as easily by birds. Therefore, this is the wire that is usually protected with bird flight deflectors. For nighttime protection, this distinction is not as relevant as both types of wires can difficult for birds to visually detect.

### SUMMARY

According to one aspect of the claimed subject matter, there is provided an apparatus for diverting birds from flying into hazards during daytime, nighttime and/or poor weather conditions. According to another aspect of the claimed subject matter, a method for diverting flying birds from hazards is disclosed.

Embodiments address the limitations of present passive bird flight diverter devices. For example, one embodiment includes a high contrast reflector that is optimized for bird diversion during daylight. Other examples which can be used at night and in fog, rain or other adverse weather conditions wherein reflectors are minimally effective, include embodiments with an illuminated marker designed specifically for alerting birds to one or more hazards.

Embodiments address the need for a systems approach to optimizing a total collision avoidance configuration. Two examples which can be used with embodiments are communication towers and electric utility power lines.

For communication towers with guy wires, an embodiment of the convenient collision avoidance system includes installing marker lights on the tower and reflectors on the guy wires.

According to another aspect of the claimed subject matter, an apparatus is provided for warning bird of hazards, the apparatus comprising an enclosure, at least one light emitter for directing light within a predetermined beam width between ten and forty eight degrees full width half magnitude, a light emitter controller for controlling said at least one light emitter, and a power source. The light emitter controller provides power to and controls the at least one light emitter so that light is emitted with a predetermined repetition rate to provide a visual deterrent to birds on a flight path toward the hazard.

According to another embodiment, the apparatus has a cylindrical enclosure with one or more mounting posts for mounting on a transmission wire.

According to another embodiment, the at least one light emitter has a wavelength of from 360 nm to 420 nm.

Another embodiment includes a power source that is an extraction module for taking power from a transmission wire and providing it to the light emitter controller.

According to another embodiment, the at least one light emitter has a radiometric power output of greater than 400 milliwatts at a wavelength of 400 nanometers.

According to another embodiment, the light is emitted at a predetermined intensity.

According to another embodiment, the light is emitted with a predetermined on/off duty cycle.

According to another embodiment, the duty cycle is 25% at a repetition rate of 4 to 8 seconds.

According to another embodiment, the light is emitted with a duty cycle and with a repetition rate that can be changed as desired by the user.

Other embodiments also include one or more light reflectors for reflecting at least a portion of the light emitted from the one or more light emitters.

### BRIEF DESCRIPTION OF THE DRAWINGS

FIG. 1 depicts an embodiment of the claimed subject matter used with a a section of a communications tower structure along with its associated guy wires.

FIG. 2 depicts an embodiment of the claimed subject matter used with a a section of a communications tower structure along with the tower's associated guy wires.

FIG. 3 illustrates a cylindrical reflector used with embodiments of the claimed subject matter.

FIGS. 4A and 4B show a before and after installation illustrations of a reflector cross section according to embodiments of the claimed subject matter.

FIG. 5 illustrates an enclosure according to embodiments of the claimed subject matter.

FIG. 6 illustrates a light bar heat sink component according to embodiments of the claimed subject matter.

### DETAILED DESCRIPTION OF THE EMBODIMENTS

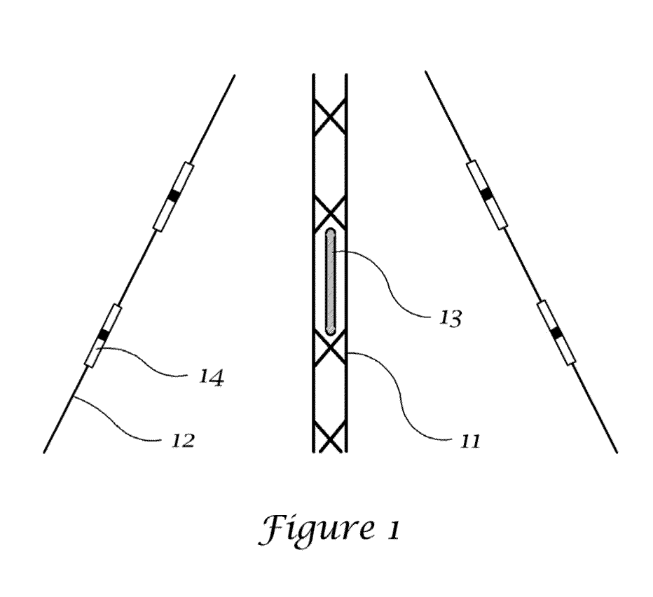

According to embodiments of the claimed subject matter, various apparatuses, systems and methods systems for diverting flying birds from hazards are provided. The apparatuses and systems of the claimed subject matter may be generally described with the reference to FIGS. 1-6 showing, but not limited to, certain exemplary embodiments of the inventive subject matter.

More specifically, an apparatus is provided for diverting a flying bird from at least one hazard. In several of the embodiments, the reflector component is a “drop on” installation product that is a tubular structure that can substantially or completely surround a power line wire, ground wire or a guy wire thereby providing low neutral wind resistance to the apparatus. Many of the embodiments include features of high brightness, high contrast, ease of installation, all dielectric materials, long operational lifetime, and minimum weight.

In several embodiments, a marker light provides multiple sets of sequentially lighted flashing lights. A horizontal line reference is produced using multiple lights along the length of the marker light enclosure. Narrow beam width lights are directed along the flight path and can include ultraviolet lights. If needed or desired, wider beam width lights are directed at adjacent wires that have reflectors added to them. In many of these embodiments, the use of high reliability components and a sealed enclosure provide an operational lifetime of 25 years.

In many of the embodiments, efficient high power LED light sources emitting in the violet and ultra violet spectrum are used. These short wavelength lights can be just noticeable to the human eye so these types of flashing lights would not normally be a distraction to people located in proximity to the lights. Additionally, the use of a cool white high efficiency LED, if desired, can provide a broad spectrum visible light with a peak emission in blue. Without the constraints of FAA defined lighting, many embodiments can use a variety of lighting spectrum, lighting distribution and operational modes and these various combinations can be optimized for different bird collision avoidance environments such as urban settings, back country settings and migratory patterns of specific species.

Many of the embodiments can be used to allow birds to detect one or more small (or large) power line wires, guy wires or other types of wires and structures in adequate time to avoid a collision. When placed into use with a power line or guy wire, several of the embodiments will increase the physical size of the wire section covered by adding a surrounding volume to the wire and/or providing a length of the embodiment on the wire adds a visual horizontal line reference that can be seen by the birds easier than when the wire is used without the embodiment.

In many of the embodiments, the use of black and white segments on the reflectors may help increase brightness and contrast between the visual elements leading to improved object detection. Birds have a visual spectrum over a broader range than visual range of humans and this range includes the near ultraviolet spectrum. To take advantage of this bird physiology, many of the embodiments implement wide-spectrum reflector surfaces that can be efficient and use wide-spectrum white light sources with a high color temperature, for example a high blue content. Many of the embodiments use illumination sources that include violet and ultraviolet light in order to better calls the attention of the birds so that they divert away from the hazard near the embodiment.

In many existing bird diversion systems, birds experience disorienting effects from artificial light sources, especially when fixed lighting is used in poor weather conditions. To counter these problems, many of the embodiments generate an intermittent light (a flashing light) with a flashing rate that gives a warning to the bird and at the same time allows a transfer of the illumination to the opposite side of power line. Additionally, many of the embodiments use narrow-beam light sources directed at bird flight path levels to maximize the possibility of drawing birds' attentions to the hazard on which the embodiments are deployed.

To maximize bird protection in nighttime, fog and rain conditions, an illuminated marker light that matches the visual acuity of birds is desired. In many of the embodiments used during the nighttime, a wide-spectrum white light source can be used. In embodiments used in fog and rain conditions, the optical transmission of light can be increased and/or maximized with the use of violet to ultraviolet regions of the spectrum. Specifically, an ultraviolet light source will penetrate fog ten times farther than green light and fifty times farther than red light so embodiments used in poor weather conditions may include one or more ultraviolet light sources. In several embodiment, the use of only ultraviolet light would minimize “light pollution” which may be desirable in many communities or in specific operating environments.

In several embodiments, the illumination is concentrated within a certain vertical and/or horizontal range depending on the orientation of the embodiment in order to increase efficiency and provide a greater distance to first detection by a bird. The ranges may also be adjusted for a particular target animal's field of view or the extent of the observable world that the is seen by the animal such as a bird. Different animals have different fields of view, depending on the placement of the eyes. Other conditions which can be accounted for include the degree of obstruction or contrast degradation of a particular viewing scene due to air contaminants or weather.

In many of the embodiments, concentrated illumination directed along a normal flight path relative to the hazard such as power lines will provide the highest brightness. These embodiments may also use narrow beam light sources and direct illumination into the flight path of birds and medium beam sources for illumination of adjacent-line reflectors.

In other embodiments used with transmission lines of up to five hundred thousand volts, an anti-corona enclosure for the marker light may also be used. The reflector may be constructed using all dielectric materials known to those skilled in the art.

Many of the embodiments provide for a “snap on” installation of the reflector so that the installation and maintenance requirements are minimized.

Some of the embodiments use existing line-powered power pick-off technology known to those skilled in the art for the light power source. These embodiments may also use select ultraviolet resistant materials and high reliability components to provide a maintenance free operational lifetime of about 25 years.

In one embodiment used with transmission lines which typically consist of one or more sets of three power wires and one or more ground wires at the top of the tower, diversion of birds from the multiple wires is achieved using a line-powered marker light on one of the power wires and reflectors on one or more of the other wires. Referring now to the figures, FIG. 1 shows a section of a communications tower structure along with its associated guy wires. Communications towers present a significant danger to birds due to their FAA required lighting and the use of guy wires on many tall towers. A collision avoidance system for all environmental conditions including inclement weather conditions must be able to direct flight beyond the FAA tower lighting and also alert birds to the guy wires. In FIG. 1, a tower marker light 13 is installed on the tower structure 11 and multiple high contrast reflectors 14 are installed on the guy wires 12. The reflectors 14 are placed on multiple guy wires 12, if present, and located so the tower marker light 13 will illuminate each of the wires 12. FIG. 1 illustrates four high contrast reflectors 14 in use although more reflectors 14 can be used along the height of the tower.

The flight path lighting is intended to provide situational awareness for birds from as great a distance away as practical. The radiometric power output of the UV sources in this product example is 1,200 milliwatts for the three LED's on each side. This level is intended to support worst-case weather conditions of fog and rain. The illumination directed at the guy wires is close in and does not need to be UV, unless there is a need to limit visible “light pollution” of the area environment or a flashing light is considered annoying.

Although the illustrated embodiment in FIG. 1 consists of a marker light mounted on the tower structure and four reflectors mounted on the two illustrated guy wires, the embodiment can also be installed in various other configurations including repeating the entire configuration shows one or more times along the length of the tower to provide additional coverage for diverting birds from their flight paths.

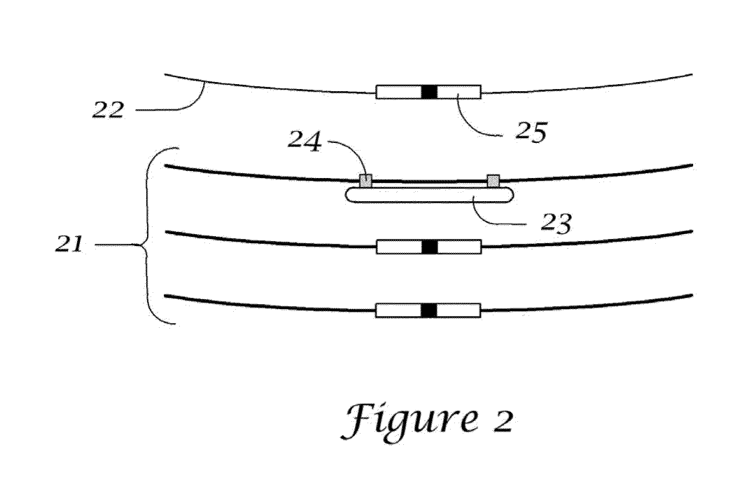

FIG. 2 shows a section of a typical electrical power transmission line consisting of three current-carrying wires and a shield (ground) wire on top. The illustrated embodiment consists of a marker light mounted on the highest current-carrying wire and three reflectors mounted on adjacent wires. In this embodiment, two power modules extract power from the wire to operate the marker light. As noted before, this embodiment can be configured differently and also repeated one or more times along the length of the wires between supporting towers.

In this illustrated embodiment, a catenary marker light 23 is installed on the topmost power transmission line 21 in order to provide a visual deterrent to birds on a flight path toward the power line hazard and well as to provide an illumination source to identify the other lines 21. The catenary marker light 23 is powered by power modules 24 and the power modules 24 are used to mount the light 23 to the line 21. Multiple high contrast reflectors 25 are installed on the top ground wire 22 and the other power transmission lines 21 and the reflectors 25 are arranged in a stacked configuration so that they can reflect light emitted from light 23.

In this embodiment, power for the marker light 23 is obtained from the transmission line 21 so the marker light 23 is attached to one or more power modules 24 which themselves are installed on a current-carrying line 21 in order to power the marker light 23. The reflectors 25 can also be installed on current-carrying lines as well as non current-carrying lines or structures.

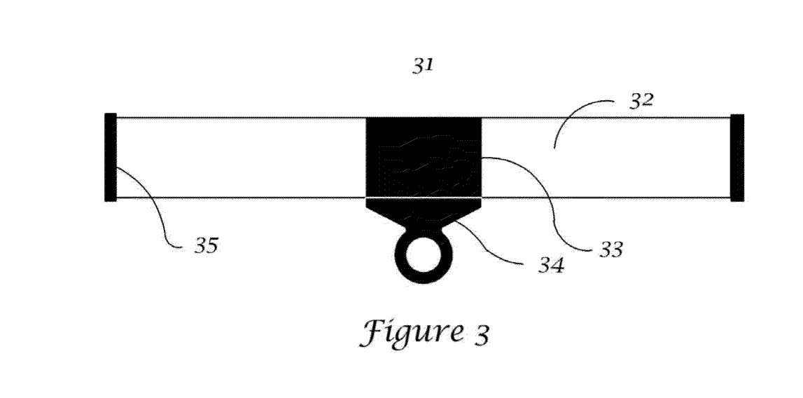

FIG. 3 illustrates a high contrast reflector according to an embodiment of the claimed subject matter. The high contrast reflector 31 shown is two feet long and three inches in diameter. The form of the reflector 31 provides a linear object that can be positioned so that it is aligned with the direction of the wire (not shown). The low reflectance black surfaces and the high reflectance white surfaces provide maximum contrast and edge definition. As shown in FIG. 3, the white diffuse film 32 and black diffuse film 33 materials are bonded to the tubular surface of the reflector 31. In this embodiment, the additional polytetrafluoroethylene, PTFE, (Teflon™) thin film is 5 mil thick and covers the white film. This thin film provides long term UV protection as well as a broad spectrum reflective capability. It is secured by the edge trim along the bottom of the reflector 31 (not shown). The end trim 35 shown on either end of the reflector 31 is constructed of black neoprene rubber or a similar material. One or more end seals (not shown) are constructed of closed cell silicone foam rubber that clamp around the wire to securely hold the reflector in place without damaging the wire and also seal the ends of the reflector 31. Also shown is a handle 34 which can be used for installation and which can be detached after use, if desired.

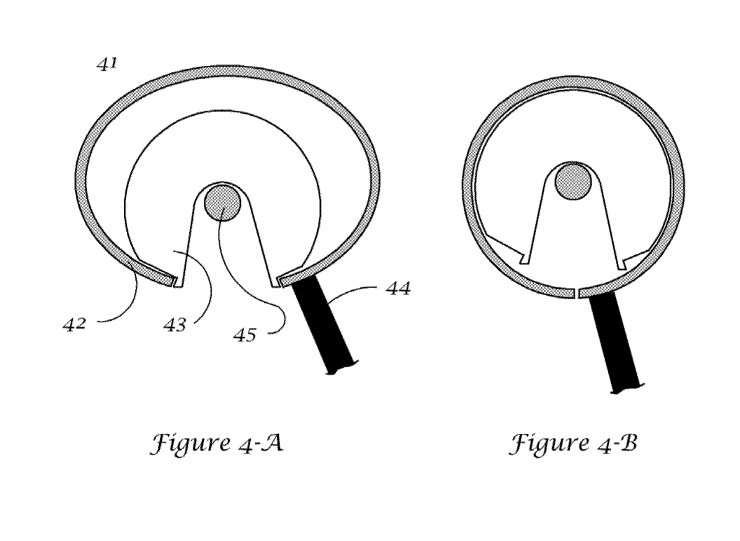

FIGS. 4A and 4B illustrate cross sections of a reflector in an embodiment according to the claimed subject matter. FIGS. 4A and 4B show a breakaway side views of the reflector 41. FIG. 4A is a “before” view and FIG. 4B is a view “after” the reflector 41 is secured to a wire 45. In FIG. 4A, an installation spacer 43 holds the slot along the length of the reflector 41 open so it can be positioned over the wire 45.

The substrate of the high contrast reflector surface 42 is a polycarbonate (also known as Lexan™) tube that has been split lengthwise. Because of the high internal compressive force of the fabricated tube, it is possible to provide a “snap on” reflector that will securely clamp onto a ground wire, guy wire or power line. In this embodiment, two pairs of installation spacers 43 are only needed for installing the reflector. They hold open the length of the reflector 31 as shown in FIG. 4A so it can be positioned onto the wire 45. The handle 44 can then be pulled away from the reflector 41 thereby releasing the spacers 43. Once the handle 44 is pulled, the shell of the reflector 41 is released from the installation spacers 43 and it closes shut with the reflector end seals clamping onto the wire. In this embodiment, the clamping force that secures the reflector 41 to the wire 45 is over 5 pounds per foot.

These embodiments use an apparatus with one or more installation spacers that are used to hold open the reflector surface 42 so that it can be installed surrounding the wire 45. In this embodiment, the spacer 43 also includes two pairs of spacer ends. The ends are tied together with a connecting bar (not shown) so that when the handle 44 is pulled, the ends remain perpendicular with the wire while at the same time the ends are forced into the cylinder. This spacer configuration prevents the edges of the reflector surface 42 from overlapping on each other when the handle 44 is pulled. These embodiments and methods of attaching reflectors 41 allow any other type of apparatus to be attached to wires such as transmission wires without causing unnecessary damage to the wires or without promoting corrosion of the wires.

In many embodiments only dielectric (non-metallic) materials are used so that the reflector can be installed on high voltage lines without introducing corona. These embodiments also have a reflector that provides greater than 80% reflectivity and that is able to maintain its performance level for 25 years. The reflector of this embodiment also provides a contrast ratio between the black and white segments of greater than 20:1.

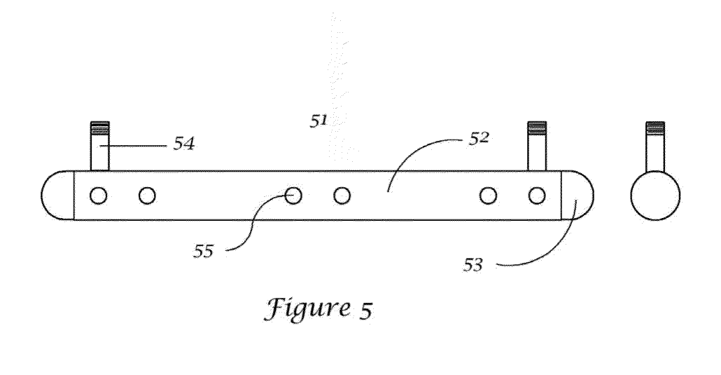

FIG. 5 illustrates a catenary marker light according to embodiments of the claimed subject matter having an enclosure has a cylindrical center with a hemisphere shaped component for sealing each end of the enclosure. The catenary marker light 51 can be used to provide an illuminated source that is visible at night and in adverse environmental conditions such as fog, rain and air pollution so that birds can detect the light source earlier and divert their flight paths away from the hazard.

The enclosure 52 of the catenary marker light 51 is constructed of a thin wall stainless steel tube with hemispherical ends 53. The enclosure 52 and the ends 53 may be constructed out of any suitable material and shape known to those skilled in the art and as desired. In other embodiments, the shape and ends of the enclosure 52 is adapted to the specific structure of the hazard or hazards so that the flight paths of birds are diverted away from the one or more hazards in a similar fashion as they are from light 51.

In this illustrated embodiment, the enclosure 52 is 34 inches long and three inches in diameter. This enclosure shape and size is intended to prevent corona on power lines up to five hundred thousand volts. The size and shape of the enclosure 52 may be adjusted as desired for various other hazard structures. The light windows 55 use borosilicate glass (also known as Pyrex™) to allow extended transmission of light including ultraviolet light. In this illustrated embodiment of the catenary marker light 51, only six of the seventeen windows positioned on each of the sides of the enclosure are shown. In other embodiments, the number, placement and shape of the one of more windows 51 can be changed as desired.

The illustrated windows 51 allow the enclosure to be environmentally sealed while at that same time allow transmission of the light from the light sources out of the enclosure. In this way, the sealed enclosure 52 meets the highest environmental requirements for outdoor use. In other embodiments, the reflective capability of the reflector design can be added to this enclosure.

Two mounting posts 54 are provided to secure the marker light 51 and position it in alignment with the length of the wire (not shown.) In this embodiment, each of the mounting posts 54 connect to a power extraction module that takes power from the current in the wire and the mounting posts provide a convenient interface constructed of ¾″ threaded pipe. In other embodiments, only one post 54 may be used for connecting and/or power extraction and the power extraction capability is well known to those skilled in the art. Additionally, different sizes and shapes of posts 54 may be used in other embodiments.

In several of the embodiments, the post is a 3″ long SS pipe with a ¾″ NPT (National Pipe Thread) although any other suitable post with a suitable size and dimension may also be used with the disclosed embodiments.

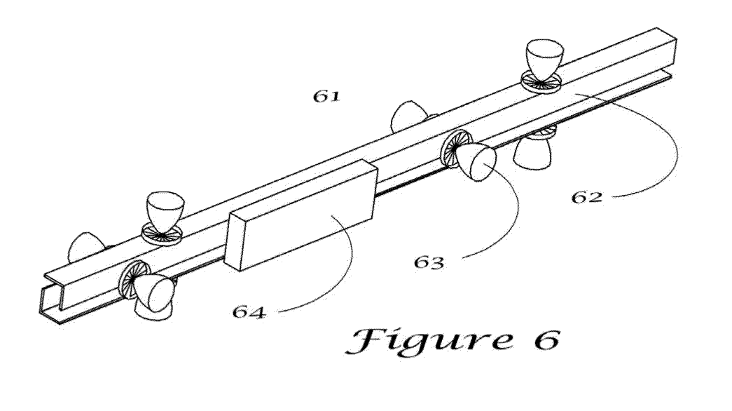

FIG. 6 illustrates an internal light bar 61 according to an embodiment of the claimed subject matter. In several embodiment, the light bar 61 is used to provide support and mounting for a variety of LED sources in any number of quantities and locations. As illustrated in the embodiment shown in FIG. 6, a LED controller 64 comprised of electronics designed to control the LED emitters is also mounted on bar 61 along with a number of reflectors 63 mounted to a heat sink 62, another component of light bar 61. The light bar 61 including all its components can be easily inserted into the catenary enclosure and, in many of the embodiments, the light bar 61 extends the length of the enclosure (not shown) and is also centered in the enclosure.

In this embodiment, the array of LED's with their reflectors 63 and LED controller 64 are mounted onto the light bar heat sink 62. The emitted beam pattern of light is defined by the use of metalized reflectors 63 mounted on each LED. In these embodiments, the reflectors 63 provide relatively narrow beams of light horizontally along putative bird flight paths in both directions outward from the wire's position. In the illustrated embodiment of FIG. 6, there are two white LED's positioned on top and the bottom of heat sink 62, and two white LED's positioned on each of the sides of heat sink 62. In this embodiment, each of the UV wavelength LED's has a radiometric power output of greater than 400 milliwatts at a wavelength of 400 nanometers. LED's with a shorter wavelength, for example 365 nm, can also be used with light bar 61 as can LED's with longer wavelengths.

In other embodiments, the light bar 61 can also include LED's to provide additional horizontal lights and/or vertical lighting for the areas above and below the wire to illuminate the other transmission lines. In several embodiments, a reflector 63 with a wider beam of light can be used. In many of the embodiments, a narrow beam reflector is 12 degrees FWHM (full width half magnitude) and a wide beam reflector is 28 degrees FWHM. Any suitable range could be used including any range between 10 degrees and 48 degrees. Also, in many of the embodiments, the reflector is a metalized plastic cone that will not deteriorate under UV light. Any suitable narrow or wide beam reflector may be used as desired such as narrow beams greater than 12 degrees, narrow beams less than 12 degrees, wide beams greater than 28 degrees and wide beams less than 28 degrees.

In this embodiment, the controller 64 provides power to the LED's at a defined intensity and is programmed for a flashing light with a predetermined or defined on/off duty cycle and repetition rate. The defined cycle and rate can be changed as desired by the user or it can be predetermined when constructed. The expected mode of operation for flashing lights would be to sequentially light two or more banks of LED's as this would provide a lower average power relative to light output. For example, this embodiment utilities a 25% duty cycle at a repetition rate of 4 to 8 seconds although any suitable combination of duty cycles and repetition rates can be used. In other embodiment, the marker light can be set to operate continuously, during day time and at night, or it can be controlled by a light sensor to operate only in low light or in adverse environmental conditions.

The described embodiments and variations thereof can also be used with any other obstruction such as wind turbines, bridges or other types of structures. Embodiments can also be used to protect birds from the negative effects of FAA mandated lighting at airports, on buildings and cell phone towers having continuous red or white lights.

Several of the embodiments can include an additional monitoring competent for monitoring the state of the one or more devices or for using additional components to monitor external items such as flying birds, environmental conditions, atmospheric conditions and line safety conditions. In many of these monitoring enabled embodiments, a user can monitor with a mobile device, a website or a plugin/app to an existing website or mobile device platform. The use may also be optionally notified of a change or no change to any one of the conditions being monitored by the embodiments such as the operational status of the lights via the described monitoring interfaces and the internet which can be accessed through one or more wired connections, wireless connection or internet over power line connections known to those skilled in the art. Additionally, various interactivity elements can be optionally provided using these embodiments so that users can be engaged with the data as it becomes available and report status of features the embodiments as well as external items sensed by the devices such as wild fires.

Although the foregoing embodiments has been described in some detail by way of illustration and example for purposes of clarity and understanding, it will be apparent to those of ordinary skill in the art in light of the teaching of this inventive subject matter that certain changes and modifications may be made thereto without departing from the spirit or scope of the appended claims.

What is claimed is:

1. An apparatus for warning bird of hazards, the apparatus comprising:
(a) an enclosure;
(b) at least one light emitter for directing light within a predetermined beam width between ten and forty eight degrees full width half magnitude;
(c) a light emitter controller for controlling said at least one light emitter; and
(d) a power source;
(e) wherein said light emitter controller provides power to and controls the at least one light emitter so that light is emitted with a predetermined repetition rate for deterring birds from containing on a flight path toward the hazard.

2. The apparatus of claim 1, wherein said enclosure is cylindrical and has one or more mounting posts for mounting on a transmission wire.

3. The apparatus of claim 1, wherein said power source is an extraction module for taking power from a transmission wire and providing it to said light emitter controller.

4. The apparatus of claim 1, wherein said at least one light emitter has a wavelength of from 360 nm to 420 nm.

5. The apparatus of claim 1, wherein said at least one light emitter has a radiometric power output of greater than 400 milliwatts at a wavelength of 400 nanometers.

6. The apparatus of claim 1, wherein said light is emitted at a predetermined intensity.

7. The apparatus of claim 1, wherein said light is emitted with a predetermined on/off duty cycle.

8. The apparatus of claim 6, wherein said duty cycle is 25% at a repetition rate of 4 to 8 seconds.

9. The apparatus of claim 1, wherein the light is emitted with a duty cycle and with a repetition rate that can be changed as desired by the user.

10. The apparatus of claim 1, further comprising one or more light reflectors for reflecting at least a portion of light emitted from said at least one light emitter.

11. A system of providing a visual deterrent to birds on a flight path toward a hazard, the system comprising using a visual deterrent apparatus for emitting light towards the bird flight path, the apparatus comprising:
(a) an enclosure;
(b) at least one light emitter for directing light within a predetermined beam width between ten and forty eight degrees full width half magnitude;
(c) a light emitter controller for controlling said at least one light emitter; and
(d) a power source;
wherein said light emitter controller provides power to and controls the at least one light emitter so that light is emitted with a predetermined repetition rate so that light is emitted to provide a visual deterrent to birds on a flight path toward the hazard.

12. The system of claim 11, wherein said enclosure is cylindrical and has one or more mounting posts for mounting on a transmission wire.

13. The apparatus of claim 1, wherein said power source is an extraction module for taking power from said transmission wire and providing it to said light emitter controller.

14. The system of claim 11, wherein said at least one light emitter has a wavelength of from 360 nm to 420 nm.

15. The system of claim 11, wherein said at least one light emitter has a radiometric power output of greater than 400 milliwatts at a wavelength of 400 nanometers.

16. The system of claim 11, wherein said light is emitted at a predetermined intensity.

17. The system of claim 11, wherein said light is emitted with a predetermined on/off duty cycle.

18. The system of claim 17, wherein said duty cycle is 25% at a repetition rate of 4 to 8 seconds.

19. The system of claim 11, wherein the light is emitted with a duty cycle and with a repetition rate that can be changed as desired by the user.

20. A method of providing a visual deterrent to birds on a flight path toward a hazard, the method comprising:
positioning an apparatus on a hazard so that said apparatus emits light as a visual deterrent to birds on a flight path toward the hazard, the apparatus comprised of:
(a) an enclosure;
(b) at least one light emitter for directing light within a predetermined beam width between ten and forty eight degrees full width half magnitude;
(c) a light emitter controller for controlling said at least one light emitter; and
(d) a power source;
(e) wherein said light emitter controller provides power to and controls the at least one light emitter so that light is emitted with a predetermined repetition rate so that light is emitted to provide a visual deterrent to birds on a flight path toward the hazard.
